(19) United States
(12) Patent Application Publication
(10) Pub. No.: US 2014/0006071 A1
(43) Pub. Date: Jan. 2, 2014

(54) Consolidated Partnership Valuation Platform

(71) Applicants: Steven M. Sear, Atlanta, GA (US); Kristen Marie Shovlin, Atlanta, GA (US); Sara Nofziger Reid, Atlanta, GA (US); Meri C. Falciglia, Atlanta, GA (US); Shane Michael Spyak, Sharpsburg, GA (US); Nicholas Michael Schwendeman, Hastings, MN (US); Thomas William Morris, Raleigh, NC (US); Sandra R. Ruberg, Saint Paul, MN (US); Celia Julienne Payne, Smyrna, GA (US)

(72) Inventors: Steven M. Sear, Atlanta, GA (US); Kristen Marie Shovlin, Atlanta, GA (US); Sara Nofziger Reid, Atlanta, GA (US); Meri C. Falciglia, Atlanta, GA (US); Shane Michael Spyak, Sharpsburg, GA (US); Nicholas Michael Schwendeman, Hastings, MN (US); Thomas William Morris, Raleigh, NC (US); Sandra R. Ruberg, Saint Paul, MN (US); Celia Julienne Payne, Smyrna, GA (US)

(21) Appl. No.: 13/930,375

(22) Filed: Jun. 28, 2013

Related U.S. Application Data
(60) Provisional application No. 61/666,483, filed on Jun. 29, 2012.

(51) Int. Cl. G06Q 10/02

(52) U.S. Cl. CPC G06Q 10/02
USPC 705/5

(57) ABSTRACT

A consolidated partnership valuation server may include a valuation server. The valuation server may receive a plurality of ticket transactions that have been updated. From the plurality of ticket transactions, the valuation server may identify one or more ticket transactions that are associated with a partner account. Responsive to identifying the one or more ticket transactions that are associated with the partner account, the valuation server may associate one or more value-added products to each of the identified ticket transactions. Further, the valuation server may consolidate the one or more identified ticket transactions and the one or more value-added products associated with each of the identified ticket transactions. Upon consolidation, the valuation server may calculate a value of the one or more value-added products and generate a report based on the calculated value.

### CROSS REFERENCE TO RELATED APPLICATIONS

This application claims priority under 35 U.S.C. §119 to U.S. Provisional Patent Application No. 61/666,483 filed Jun. 29, 2012, and entitled “Sky Partner Valuation,” the entire contents of which are hereby incorporated herein by reference.

### FIELD OF INVENTION

This disclosure relates generally to a technical field of data processing and analysis and, in one example embodiment, to a system, method and apparatus for consolidated partnership valuation.

### BACKGROUND

Transportation companies such as airlines provide travel services to passengers. Some of these passengers may be associated with a business, such as a large corporation, an agency, and/or a small and medium size business, that may have a contractual agreement with the airline. Hereinafter, such businesses having contractual agreement with the airlines may be generally referred to as a partner of the airline. Typically, a business that is a partner to the airline may receive standard monetary benefits, such as discounted tickets according to the contractual agreement. In addition to the standard monetary benefits, to enhance customer relationship, the airlines may often provide benefits in the form of value added products and/or services that go beyond the contractual agreement, such as cabin upgrades, baggage fee waivers, free tickets, travel vouchers, etc. Information regarding the benefits beyond the contractual agreement may be stored in a data infrastructure of the transportation company.

Information regarding the benefits beyond the contractual agreements can be leveraged to generate business intelligence reports, customer reports, and/or other performance metrics. Such reports may be beneficial in improving business performance of both the partner business and the transportation company. Further, such reports may be beneficial to enhance a partnership between the partner business and the transportation company. However, even though information regarding the benefits may be available in the data infrastructure associated with the transportation company, the information may be stored as discrete pieces spread across numerous databases. Further, the same information may be referenced in using different attributes in different databases. Conventional technology may lack the ability to view the information associated with these benefits holistically. Further, convention technology may lack the ability to effectively consolidate the information stored in different databases and referenced by different identifiers. In addition, conventional technology may lack an ability to provide a standardized valuation of the additional benefits across all operations of the transportation company. Such limitations may limit the ability of the transportation company to leverage the information regarding the value added products and services in a cost efficient manner. Thus, there is a need for a technology that provides a consolidated partnership valuation.

### SUMMARY

Disclosed are a system, a method and an apparatus for consolidated partnership valuation. In one aspect, a method of a valuation server includes identifying a ticket transaction that is associated with a partner account. Further, the method includes generating, for the identified ticket transaction, a valuation repository comprising one or more identifiers that are retrieved from a plurality of databases. The one or more identifiers are retrieved such that each of the one or more identifiers reference the identified ticket transaction. Furthermore, the method includes associating a value-added product to the identified ticket transaction based on the one or more identifiers in the valuation repository. In addition, the method includes calculating, by the valuation server, a value the value-added product that is associated with the identified ticket transaction. After calculating the value of the value-added product, the method includes generating a data report based on the calculated value of the value-added product.

In another aspect, a server includes a memory and a processor. The processor is configured to identify a ticket transaction that is associated with a partner account. Further, the processor is configured to generate, for the identified ticket transaction, a valuation repository comprising one or more identifiers that are retrieved from a plurality of databases. Furthermore, the processor is configured to associate a value-added product to the identified ticket transaction based on the one or more identifiers in the valuation repository. In addition, the processor is configured to calculate a value the value-added product that is associated with the identified ticket transaction and generate a data report based on the calculated value of the value-added product.

In yet another aspect, a system includes a computer. The computer is configured to identify a ticket transaction that is associated with a partner account. Further, the computer is configured to generate, for the identified ticket transaction, a valuation repository comprising one or more identifiers that are retrieved from a plurality of databases. The one or more identifiers are retrieved such that each of the one or more identifiers reference the identified ticket transaction. Furthermore, the computer is configured to associate a value-added product to the identified ticket transaction based on the one or more identifiers in the valuation repository. In addition, the computer is configured to calculate a value the value-added product that is associated with the identified ticket transaction.

These and other aspects, features and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE FIGURES

Example embodiments are illustrated by way of example and not limitation in the figures of the accompanying drawings, in which:

FIG. 1 illustrates an exemplary operating environment of a consolidated partnership valuation system, according to certain exemplary embodiments of the present invention.

FIG. 2 illustrates an exploded view of a valuation server of the consolidated valuation system, according to certain exemplary embodiments of the present invention.

FIG. 3 is a flow chart that illustrates end to end data flow with respect to the valuation server, according to certain exemplary embodiments of the present invention.

FIG. 4 is a flow chart that illustrates a process of identifying transactions associated with a partner account, according to certain exemplary embodiments of the present invention.

FIG. 5 is a flow chart that illustrates a process of building a valuation repository for the transactions associated with a partner account, according to certain exemplary embodiments of the present invention.

FIG. 6 is a flow chart that illustrates a process of consolidating information regarding value added products associated with each partner for each transaction identified as a partner transaction, according to certain exemplary embodiments of the present invention.

FIG. 7 is a flow chart that illustrates a process of calculating values associated with the consolidated services and value added products, according to certain exemplary embodiments of the present invention.

FIG. 8 is a flow chart that illustrates a process of real-time alert generation, according to certain exemplary embodiments of the present invention.

FIGS. 9 and 10 illustrate example interactive data reports, according to certain exemplary embodiments of the present invention.

FIG. 11 illustrates an example alert report, according to certain exemplary embodiments of the present invention.

Many aspects of the invention can be better understood with reference to the above drawings. The elements and features shown in the drawings are not to scale, emphasis instead being placed upon clearly illustrating the principles of example embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the Detailed Description that follows.

### DETAILED DESCRIPTION

Disclosed are a system, a method and an apparatus for a consolidated partnership valuation. Technology of the consolidated valuation partnership platform will be described below in detail using various embodiments. The description begins by defining various terms that may be referenced in the course of the following description.

The term ‘ticket transaction’ as used herein may generally refer to any appropriate data record that provides travel information. The data record may generally provide information regarding a single segment of travel. A travel may include one or more segments, for example, an travel from point A-C may include two segments, one from A-B and another from B-C. Each segment of travel may be generally referred to a travel leg (hereinafter ‘flight leg’). In an example embodiment, the data record may include one or more attributes that identify a single flight leg, for example a ticket identifier, an issue date, an origin date, a destination airport, airline code, a flight number, etc. One of ordinary skill in the art can understand and appreciate that the data record may include any appropriate number of attributes to identify the segment of travel, without departing from a broader scope of the disclosure. Hereinafter, the term ‘ticket transaction’ may be referred to as a ticket.

The term “value-added products' as used herein may generally refer to any appropriate service, goods, and/or products that are provided to a customer beyond a contractual agreement. Further, the value-added products may refer to performance data as well. Examples of such value-added products may include, but not limited to, loyalty program benefits, compensations provided for delayed or cancelled flights, free tickets, cabin upgrades, complimentary Wi-Fi on flight, direct customer care lines, membership status upgrade, baggage fee waivers, flight delays, flight cancellations, other flights performance data, etc. Hereinafter, the value-added products may be generally referred to as incentive services.

The term “data report” as used herein can generally refer to any appropriate processed, visually presentable, and/or a user understandable format of the calculated value of benefits provided beyond a contractual agreement. In some embodiments, the data report can also include a value of benefits provided within a contractual agreement. The data report may be interactive in that, a user may be provided with a high level valuation report, wherein each data point of the high level report is selectable. The selection of the data point may open a more detailed report associated with the selected data report. Further, the user can search within the report for specific data points and values. In addition, the user can enter a time period for generation of the data report, i.e., the user can request to see the data report for a time period requested by the user. The user may also be provided permission to read from and write into the data report.

In one embodiment, the data report can include a statistical or analytical information associated with the value of the incentive services. In another embodiment, the data report could be any trends or patterns that can be drawn from the value of the incentive services. In some embodiments, the data report can include reproduction of raw, unintelligent and/or unprocessed data in a visually presentable format. For example, information stored in any of the databases of the partnership valuation systems, such as the partnership valuation report database may be unintelligently reproduced in the data report. In an example embodiment, the data report can be represented in the form of tables, graphs, percentages, charts, etc. In one example embodiment, the value of each incentive service may be directly used as data points in the data report. In another example embodiment, the value of incentive services may be further processed to form data points for the data reports, e.g., percentages, averages, mean values, trends, etc.

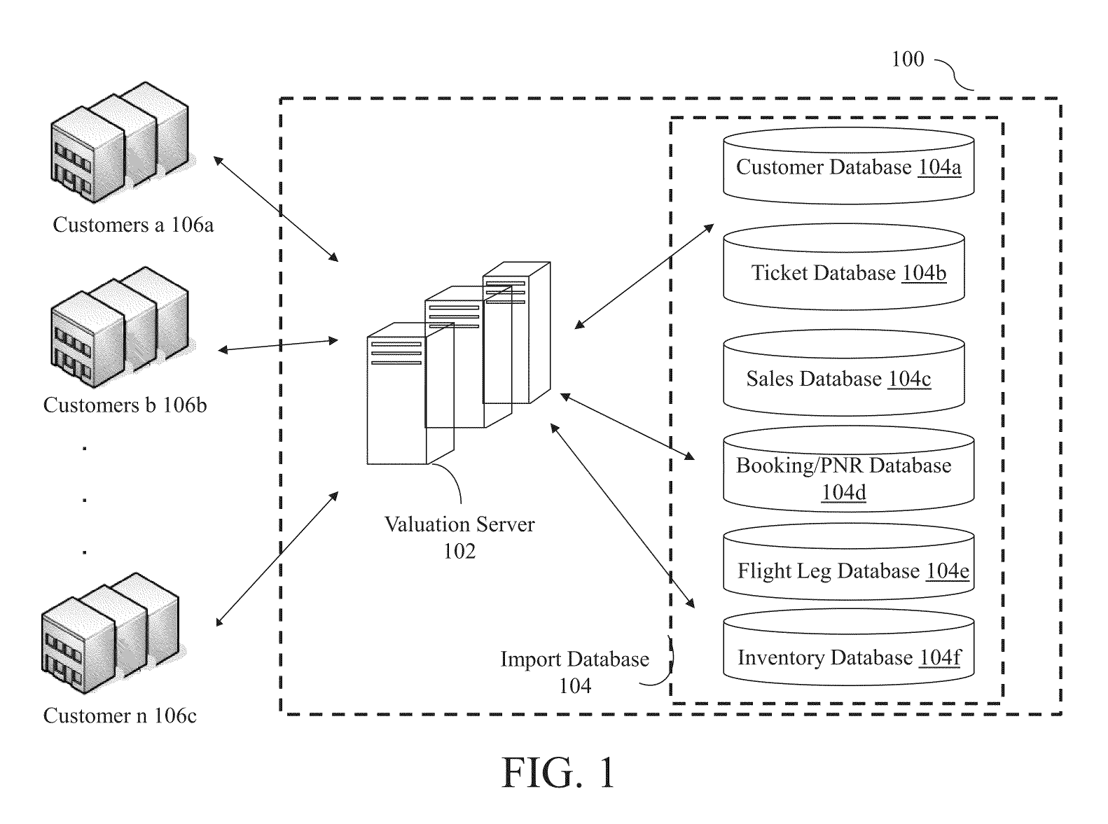

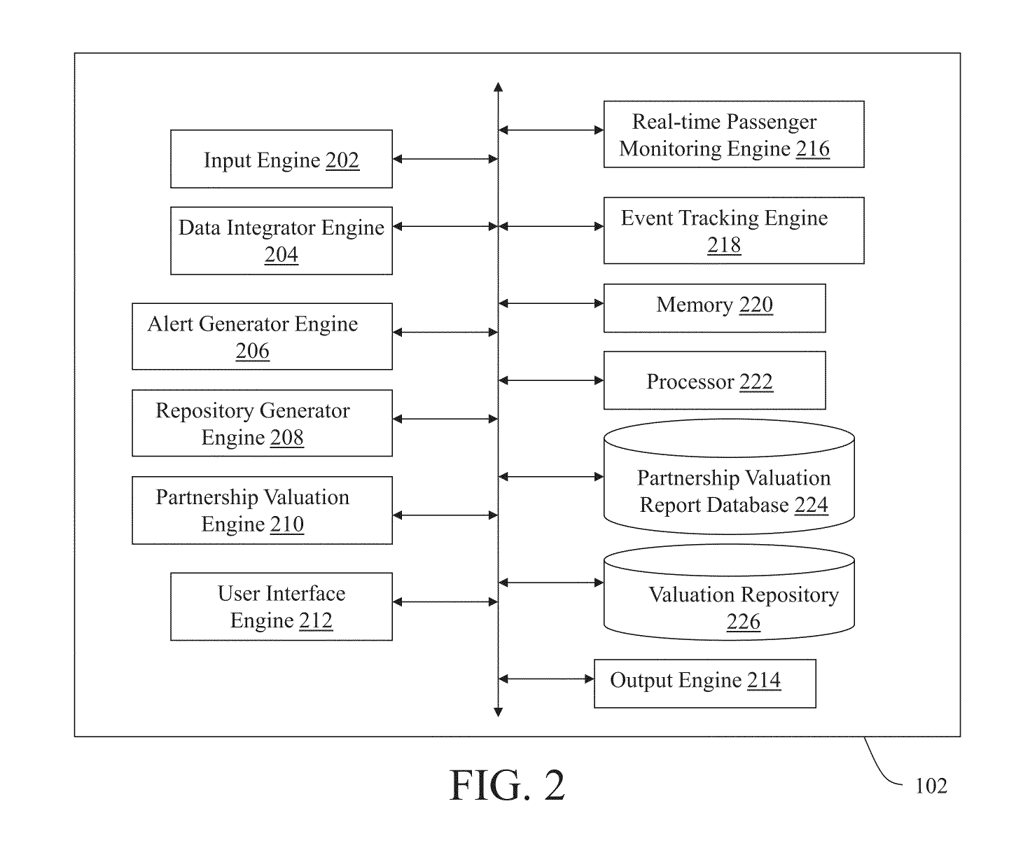

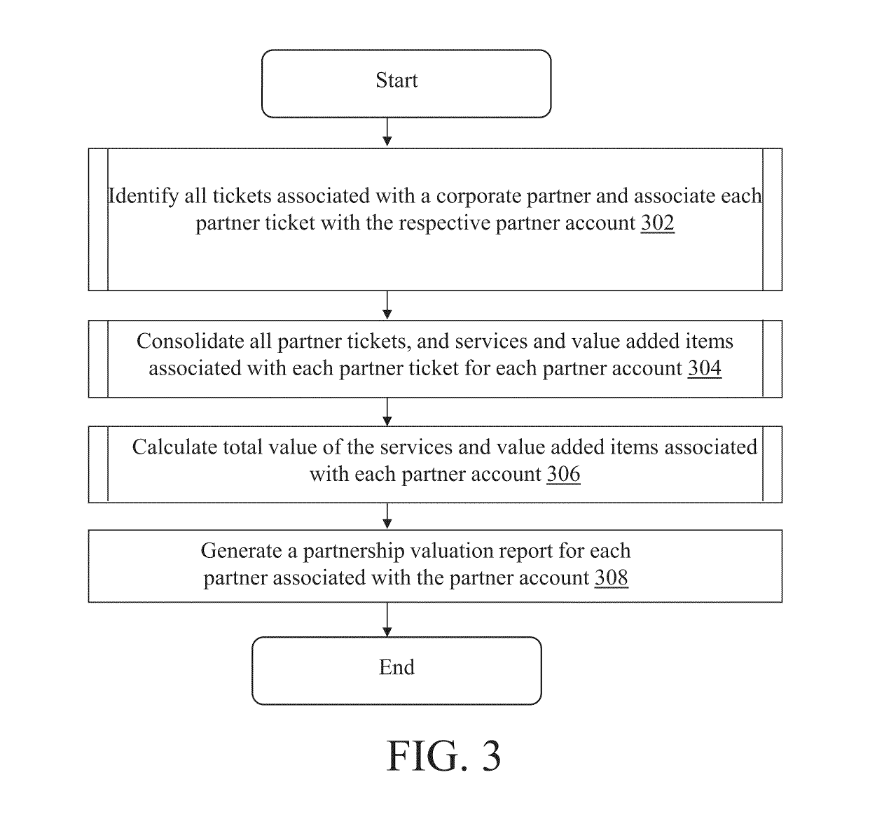

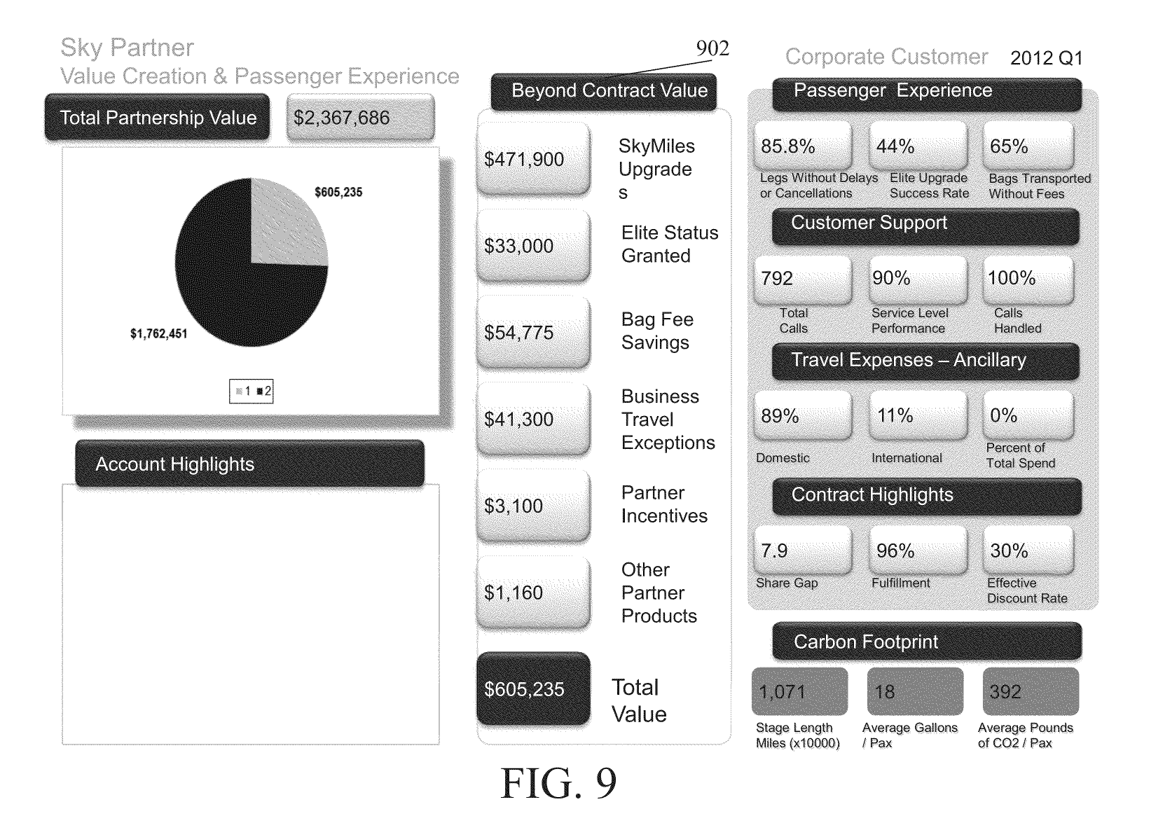

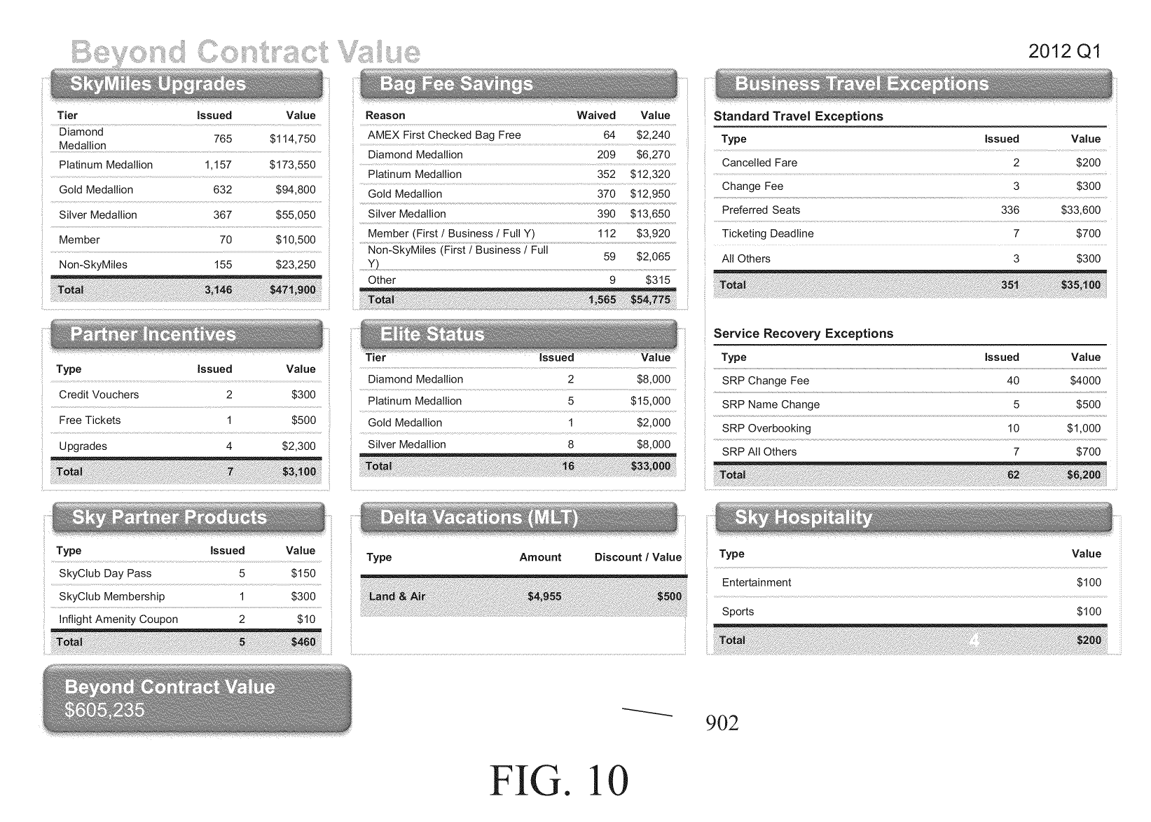

Technology for partnership valuation platform will now be described in greater detail with reference to FIGS. 1-10, which describe representative embodiments of the present invention. In the following description, for purposes of explanation, numerous specific details are set forth in order to provide a thorough understanding of the various embodiments. FIGS. 1-2 describe the consolidated partnership valuation system. FIGS. 3-8 describe the different operations of the consolidated partnership valuation platform using suitable illustrations and flowcharts. Further, FIGS. 9-10 describe the consolidated partnership valuation platform using exemplary data report snapshots.

The present invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting and among others supported by representations of the present invention.

Using a partnership valuation platform, a transportation company may calculate a value of any appropriate incentive service, i.e., goods, services, and value-added products that are provided to a partner beyond a contractual agreement. Further, the calculated value may be used to generate an interactive data report that can be viewed by both the transportation company as well as the partner business. Even though, the following detailed description refers to the transportation company as an airline, one of skill in the art can be understand and appreciate that transportation company as an airline may be replaced any other means of transportation such as trains, cruise ships, buses, rental car agencies, and/or any other appropriate customer service operation etc., without departing from the broader scope of this disclosure.

The partnership valuation platform may include a valuation server. The valuation server may be coupled to one or more databases through a wired or wireless communication link and configured to receive and/or extract information from the one or more databases. In one embodiment, the databases may be internal to the consolidated partnership valuation platform. In another embodiment, the databases may be external to the consolidated partnership valuation platform, i.e., the databases may be associated with a third party. In yet another embodiment, the databases may be distributed in that some may be within the consolidated partnership valuation platform while others may be external to the consolidated partnership valuation platform.

The valuation server may periodically receive a list of tickets from a repository that collects tickets that are generated within an airline infrastructure and/or from a third party. In one embodiment, the list of tickets may be received in a batch format over periodic intervals. In another embodiment, the list of tickets may be received in near real-time. The list of tickets may include information regarding tickets that have been updated over a set period of time. For example, the valuation server may receive a list of tickets that have been updated within the last 24 hours. The list of tickets may include both tickets that are associated with a partner business and tickets that are not associated with any partner business (e.g., independent leisure traveler). Upon receiving the list of tickets, the valuation server may identify the tickets that are associated with a partner business. Further, the valuation server can categorize the identified tickets into tickets associated with a corporate partner, an agency partner, and/or a small and medium business partner, and send them for further processing. In one embodiment, the tickets that are not associated with a partner business may be discarded. In another embodiment, the tickets that are not associated with a partner business may be stored in a separate database, but not sent for further processing.

Upon identifying the tickets that are associated with a partner business, the valuation server builds a valuation repository comprising a list of identifiers referencing the identified ticket. The valuation repository is built for each partner and each ticket associated with the partner. For example, if four tickets are identified as associated with partner X, then the valuation server creates a valuation repository for partner X that may include information associated with the four tickets. In addition, using information from the ticket associated with partner businesses, the valuation server populates the valuation repository with additional identifiers. The additional identifiers may be extracted from the one or more databases to which the valuation server is coupled. However, if the valuation repository has already been built, the valuation server may update the entries of the valuation repository based on the tickets associated with the partner businesses. Updating the valuation repository may include adding, deleting, and/or modifying the entries in the valuation repository.

Once the valuation repository is built and/or updated, the valuation server uses the identifiers listed in the valuation repository to retrieve information regarding one or more incentive service associated with each ticket associated with the partner business. For example, if four tickets are identified as associated with partner business X and each of the four tickets have a free upgrade provided, the valuation server may use the identifiers listed in the valuation repository for the partner X to retrieve information associated with the free upgrades provided to each of the four tickets. Hereinafter, a ticket associated with a partner business may be referred to as ‘partner ticket’. The incentive service information may include a monetary value assigned to the incentive service and the number of times the incentive service was used in associated with the partner ticket. For example, a ticket upgrade incentive may have a $400 value. Further, the value of each incentive service may be standardized for all operations and across all branches of the transportation company. The standardized value of each incentive service may be pre-defined and may be upgraded periodically (i.e., annually, monthly, weekly, after each meeting with partner business, etc.). For example, if Delta sets the value of a ticket upgrade as $400, the value remains the same throughout all databases and every branch of Delta. In addition, Delta may choose to update the value on a monthly, daily, and/or yearly basis.

Once the incentive service information is retrieved, the information may be imported into the partnership valuation report database. In some embodiments, the valuation server may categorize the incentive services based on different data points made available in the data report. In some embodiments, the categorized incentive services may be stored in different tables of the database. Further, the total value of incentive services in each category/table may be calculated. In one embodiment, the calculated values may be used as data points in the data report. In another embodiment, some of the calculated values may be further processed to form derived data points for the data report. For example, additional processing is performed when data needs to be represented as percentages or if comparison needs to be drawn for performances between different years.

As described above, once the total value of each incentive service is calculated, the valuation server may generate a data report, wherein the data points of the data report may be represented by the calculated total value of the different incentive services or a variation of calculated total value. Further, the processing server may be configured to filter and format the data report for presentation to the end user via the web interface. In some embodiments, the data reports may be presented to the end user through any appropriate visual, auditory, tactile, or olfactory means.

Moving now to discuss the figures further, an exemplary embodiment of the present invention will be described in detail. First, FIG. 1 will be discussed in the context of describing a representative operating environment associated with partnership valuation platform according to certain exemplary embodiments of the present invention. FIG. 2 will be discussed, making exemplary reference back to FIG. 1 as may be appropriate or helpful. Further, the remaining FIGS. 3-10 will be discussed, making exemplary reference back to FIGS. 1 and 2 as may be appropriate or helpful.

As further discussed below and in accordance with certain embodiments of the present invention, FIG. 1 illustrates an exemplary system that is useful for partnership valuation; while FIG. 2 illustrates exemplary system elements of a valuation server of the partnership valuation platform.

Referring now to FIG. 1, this figure illustrates an exemplary operating environment of a partnership valuation system, according to certain exemplary embodiments of the present invention. In particular, FIG. 1 illustrates a valuation server 102, an import database 104, a customer database 104a, a ticket database 104b, a sales database 104c, a booking/PNR database 104d, a flight leg database 104e, an inventory database 104f, and customers 106a-n.

The partnership valuation system 100 comprises one or more databases, which are herein referred to as import databases 104. In some embodiments, the import database 104 may be internal to the partnership valuation system 100. For example, the import database 104 may be an internal database maintained by a transportation company, such as an airline. In other embodiments, the import database 104 may be external to the partnership valuation system 100 and maintained by a third party. In an example embodiment, the import database 104 can hold information about all the customers of the airline, ticket purchases associated with the airline, sales records, booking information, services recovery information, etc. Without being exhaustive, such information can include, for example, customer name, ticket identifier, flight leg identifier, and so on. In other words, the information hosted in the import database can include any appropriate information that can identify at least a customer account, a partner account, a ticket, and/or incentive services provided on each ticket. In another embodiment, the import database 104 can include any appropriate information that aids in generating the data report as will be discussed in FIGS. 3-8.

In one embodiment, the import database 104 may include a customer database 104a, a ticket database 104b, a sales database 104c, a booking database 104d, a flight leg database 104e, and/or an inventory database 104f as illustrated in FIG. 1. In another embodiment, the import database 104 can include lesser or additional databases other than the ones illustrates in FIG. 1. In an example embodiment, the customer database 104a may generally include any appropriate customer information, such as customer name, customer identifier, customer preferences, and/or customer care information. It may be noted that in one embodiment, some data records may be present in multiple databases, for example, the customer name may be present in the customer database 104a, the ticket database 104b, and the booking database 104d. In an example embodiment, multiple searches may be performed to extract an identifier such as the customer information.

In an example embodiment, the ticket database 104b may generally include any appropriate information associated with a ticket, such as ticket number, ticket issue date, ticket transaction code, location at which the ticket was issued, ticket revenue, and/or non-cash incentives. In an example embodiment, the sales database 104c may generally include any appropriate data representative of the ticket and/or airline service sales, such as sales identifier for a partner business, waivers information, customer experience reports, partner business information, and so on. In an example embodiment, the booking database 104d may generally include any appropriate information associated with the booking of an itinerary with the airline, such as passenger name record (PNR), ticket upgrade information, downgrade information, and/or denied boarding information. In an example embodiment, the flight leg database 104e can generally include any appropriate information associated with at least one segment of travel, such as destination, origin, flight segments that are flown, segments that are cancelled, and so on.

In an example embodiment, each of the databases of the import database 104 may include a combination of both information associated with a booking transaction (e.g., different identifiers that reference a ticket) and information associated with incentive services.

As illustrated in FIG. 1, the import database 104 may be coupled to a valuation server 102, which in turn may be coupled to one or more end users/customers 106a-n. The customers 106a-n may include, inter alia, the partner businesses, such as the corporate businesses, agencies, and/or small and medium size businesses that have a contractual agreement with the airline. In one embodiment, using a computing device, each customer 106a-n may communicate with the valuation server 102 over a wired or wireless communication link.

In example embodiment, the valuation server 102 may push the data report to appropriate customers 106a-n at regular intervals or as and when the data report is generated. A customer 106 may register to receive data reports periodically. For example, upon request, a monthly data report may be sent to the manager of a travel department of the corporate business client. In another example embodiment, the valuation server 102 may provide an application program interface through which the customers 106a-n can access information associated with the valuation server 102. In an example embodiment, information associated with the valuation server 102 may include data reports and or calculated values of incentive services. In the example embodiment, the valuation server 102 may provide the data report to the customers 106a-n through an interactive web interface. In the example embodiment, the interactive web interface may provide the customer with one or more selectable data report options. Using the selectable data report options, the customers 106a-n may request for a one or more data reports associated with the incentive services. In an example embodiment, the requested data report may be, inter alia, a graphical report, a statistical report, alerts, analytical report, etc. For example, using the web interface, a corporate business partner 106a may request a data report of partnership value from March 2001 to May 2001. The user may be provided options to enter the time frame for which the data report needs to be generated.

In one embodiment, the valuation server 102 may be configured to retrieve information regarding incentive services from the import database 104. The information regarding the incentive services may be retrieved based on entries of a valuation repository, wherein the valuation repository is built by the valuation server 102 for each ticket transaction that is associated with a partner business. Further, the retrieved information may be processed to generate a data report that include data points representative of a value of incentive services provided to a partner business. The valuation server 102 may be described below in greater detail in association with FIG. 2.

Referring now to FIG. 2, this figure illustrates an exploded view of the valuation server, according to certain exemplary embodiments of the present invention. In particular, FIG. 2 illustrates a memory 220, a processor 222, an input engine 202, a data integrator engine 204, an alert generator engine 206, a repository engine 208, a partnership valuation engine 210, a user interface engine 212, an output engine 214, a real-time passenger monitoring engine 216, and event tracking engine 218, a partnership valuation report database 224, and a validation repository 226.

As illustrated in FIG. 2, the valuation server 102 can include a processor 222. In one embodiment, the processor 222 can be a multi-core processor. In another embodiment, the processor 222 can be a combination of multiple single core processors. In one embodiment, the valuation server 102 can include a memory 220 coupled to the processor 222. The memory 220 can be non-transitory storage medium, in one embodiment. In another embodiment, the memory 220 can be a transitory storage medium. The memory 220 can include instructions. The processor 222 can execute the instructions to perform operations of the valuation server 102. In other words, operations associated with the different engines of the valuation server 102 can be executed using the processor 222. In an example embodiment, the processing server 102 can include a stand-alone data processing device or one or more distributed data processing devices.

In an exemplary embodiment, the valuation server 102 can include an input engine 202. The input engine 202 may be configured to receive inputs from the import database 104. In some embodiments, the input engine 102 may be configured to receive inputs from the customers 106a-n as well. In another embodiment, the input engine 202 may be configured to receive input from a third party that collects tickets sales information from agencies around the world. In some embodiments, the input received from the import database 104 may be in a format that is not compatible with the operations of the valuation server 102. If so, the input engine 202 may be configured to convert the received input into a format compatible with the operations of the valuation server 102. In other words, the input engine 102 may be configured to perform an extract, transform, and load (ETL) operation.

In one embodiment, the input engine 202 may be configured to receive a list of tickets at specified intervals, for example every night, every month, and so on. In another embodiment, the input engine 202 may be configured to receive information associated with a ticket in near real-time as and when the ticket is updated. The list of tickets may include information of those tickets that have been updated within a pre-determined period of time. For example, information of tickets that has been updated in the past 10 hours. In an example embodiment, a ticket may be considered as updated, if at least one attribute of the ticket has been updated or modified. Upon receiving the list of tickets, the input engine 202 may be configured to forward the list of tickets to the data integrator engine 204.

The data integrator engine 204 may be configured to receive the list of tickets that have been updated. Further, the data integrator engine 204 may be configured to identify partner ticket. In some embodiments, after identifying the partner tickets, the data integrator engine 204 may be configured to categorize the partner tickets into tickets associated with corporate businesses, agencies, and/or small and medium businesses. Further, the partner tickets may be forwarded to a repository generator engine 208.

The repository generator engine 208 may be configured to build a valuation repository 226 for each partner business account based on the received partner tickets. The partner business account may reference a partner business. ‘Building the valuation repository’ 226 generally refers to the operation of, inter alia, populating and/or updating the valuation repository 226. For example, the repository generator engine 208 may receive five tickets, three of which are associated with partner X and two of which are associated with partner Y. Continuing with the example, the repository generator engine 208 may be configured to create a valuation repository for partner X based on the three tickets and a valuation repository for partner Y based on the two tickets. If a valuation repository for a partner business has been created based on previous partner tickets, the repository generator engine 208 may be configured to update the entries of the valuation repository to include the new partner ticket information. To create the valuation repository, the repository generator engine 208 may be configured to search the import database 104 and retrieve one or more identifiers that reference the partner ticket. In one embodiment, the repository generator engine 208 may be configured to search for the additional attributes based on at least one attribute identified in the partner ticket. For example, the repository generator engine 208 may search the import database based on a ticket number, a partner identifier, a PNR number, a flight number, and/or flight date. In one embodiment, the partner identifier may include one or more identifier keys, for example, ticket designator. The valuation repository may include a list of identifiers extracted from one or more databases (e.g., import database 104) that identify a partner ticket and any appropriate information associated with the partner ticket.

Once the valuation repository is created, the repository generator engine 208 may be configured to communicate with the partnership valuation engine 210. The partnership valuation engine 210 may be configured to retrieve incentive service information associated with each partner ticket for each partner business. In one embodiment, the partnership valuation engine 210 may be configured to retrieve incentive service information using the list of identifiers included in the valuation repository of the partner business. The retrieved incentive service information may be imported to the partnership valuation report database 224. In an example embodiment, once said incentive service information has been imported, the partnership valuation engine 210 may categorize the incentive service information. The categorization may be based on the data points represented in the data report. For example, the categories may include all incentive services, first class upgrades, baggage fee savings, travel vouchers, partner incentives, passenger experience, customer support, etc. One of ordinary skill in the art can understand and appreciate that the imported incentive service information can be categorized to any desired level of granularity, for example from categories representing business level overview to categories representing customer specific overview to categories representing individual incentive service level overview, without departing from the broader spirit of this disclosure.

Further, the partnership valuation engine 210 may be configured to consolidate all partner tickets and all incentive services associated with each partner ticket for each partner business. In an example embodiment, once said data has been consolidated, the partnership valuation engine 210 may be configured to generate a total value of incentive services associated with each partner tickets for each partner. The total value may be calculated for each incentive service category and/or all incentive services. For example, the partnership valuation engine 210 may be configured to calculate total value of first class upgrades associated with partner X. The total value of first class upgrades may be $400. Similarly, the partnership valuation engine 210 may be configured to calculate total value of other incentive services such as baggage fee savings and partner incentives associated with partner X. Continuing with the example, the total value of the baggage fee savings and partner incentives may be $200 and $600 respectively. Further, the partnership valuation engine 210 may be configured to calculate total value of all the incentive services together, by adding the total values of first class upgrades, baggage fee savings, and partner incentives as $1200. As and when new partner tickets are identified or as and when there are new entries in the valuation repository, the partnership valuation engine 210 may be configured to update the calculated value to include any appropriate new entry. In addition, the partnership valuation engine 210 may be configured to store the total values in the partnership valuation report database 224 for report generation and/or other future use.

Once the total values of the incentive services have been calculated and stored, the user-interface engine 212 may be configured to retrieve the total values associated with the incentive services and generate one or more data reports. Further, the user interface engine 212 may be configured to provide a web interface through which customer 106 may access the valuation server 102. In one embodiment, the user interface engine 212 may provide an application programming interface (API) for the customer to access data stored within the partnership valuation report database 224 of the valuation server 102. Further, the user interface engine 212 may be configured to authenticate the customer 106 before providing access to the valuation server 102 and any associated data. As described above, the users authenticated to access the valuation server 202 may include, inter alia, corporate businesses, agencies, and/or small and medium size businesses.

The customers 106a-n can interact with the valuation server 102 using the web interface. The valuation server 102 can be configured to display data reports through the web interface. In one embodiment, the users can browse the data entries within the partnership valuation report database 224. In another embodiment, each customer's 106a-n access may be limited for maintaining data privacy. For example, customer X may not be provided access to customer Y's data and so on. In yet another embodiment, the access of the valuation server 202 by each customer 106a-n may be limited to viewing data reports and direct access of the database entries may be restricted.

In another embodiment, the user-interface engine 212 may customize the data report based on a user preference that may be set by a customer 106a-n. Once the data report has been generated and customized to a user preference, the output engine 214 may be configured to transmit the data report for presentation to the respective customer 106, for example customer 106a.

Further, the valuation server 102 may include a real-time passenger monitoring engine 216. The real-time passenger monitoring engine 216 may be configured to track travel actions of selected passengers associated with the partner business. Such real-time travel action may be received from real-time data retrieval sources, for example check in kiosks. In addition to the tracking travel actions of selected passengers, the valuation server 102 may be configured to monitor flight events using the event tracking engine 218. The event tracking engine 218 may be configured to listen to any flight event broadcasts. When a flight event is captured, the event tracking engine 218 sends the captured flight event to the alert generator engine 206. The alert generator engine 206 is also configured to receive travel action of selected passengers from the real-time passenger monitoring engine 216. Further, the alert generator engine 206 may compare the received information to determine if there are any flight events that affect or have already affected the travel action of the selected passenger, and correspondingly generate a real-time alert. The real-time alert may be communicated with the respective customer 106a-n through the output engine 214. The operations of the valuation server 102 associated with the partnership valuation platform may be described in further detail below in association with FIGS. 3-8.

Although specific operations are disclosed in the flowcharts illustrated in FIGS. 3-8, such operations are exemplary. That is, embodiments of the present invention are well suited to performing various other operations or variations of the operations recited in the flowcharts. It is appreciated that the operations in the flowcharts illustrated in FIGS. 3-8 may be performed in an order different than presented, and that not all of the operations in the flowcharts may be performed.

All, or a portion of, the embodiments described by the flowcharts illustrated in FIGS. 3-8 can be implemented using computer-readable and computer-executable instructions which reside, for example, in computer-usable media of a computer system or like device. As described above, certain processes and operations of the present invention are realized, in one embodiment, as a series of instructions (e.g., software programs) that reside within computer readable memory of a computer system and are executed by the processor of the computer system. When executed, the instructions cause the computer system to implement the functionality of the present invention as described below.

Turning to FIG. 3, this figure is a flow chart that illustrates end to end data flow with respect to the valuation server, according to certain exemplary embodiments of the present invention. In operation 302, the input engine 202 of the valuation server 102 may receive a list of tickets from a repository that collects tickets. As described above in association with FIGS. 1 and 2, the list of tickets may be representative of tickets whose attributes have been updated or changed within a predetermined interval of time. The interval of time may vary from seconds, minutes, hours, days, months, or years. In some embodiments, the input engine 202 may receive a ticket in near real-time as and when at least one attribute of the ticket has been modified or updated. In other embodiments, the list of tickets may be received as a batch data. For example, the list of tickets may be received at the end of each day. The received list of tickets may include tickets that are associated with a partner business (partner tickets) and tickets that are not associated with a partner business.

In addition to receiving a list of tickets from a repository that collects tickets, the input engine 202 may receive another list of tickets from a third party. The third party receives ticket sale data from agencies around the world. Those agencies report to them the corporation each ticket was sold to. In other words, the other list of tickets received from the third party may be identified as partner tickets. The input engine 202 may combine the list of tickets from the repository and the third party to form a combined list of tickets.

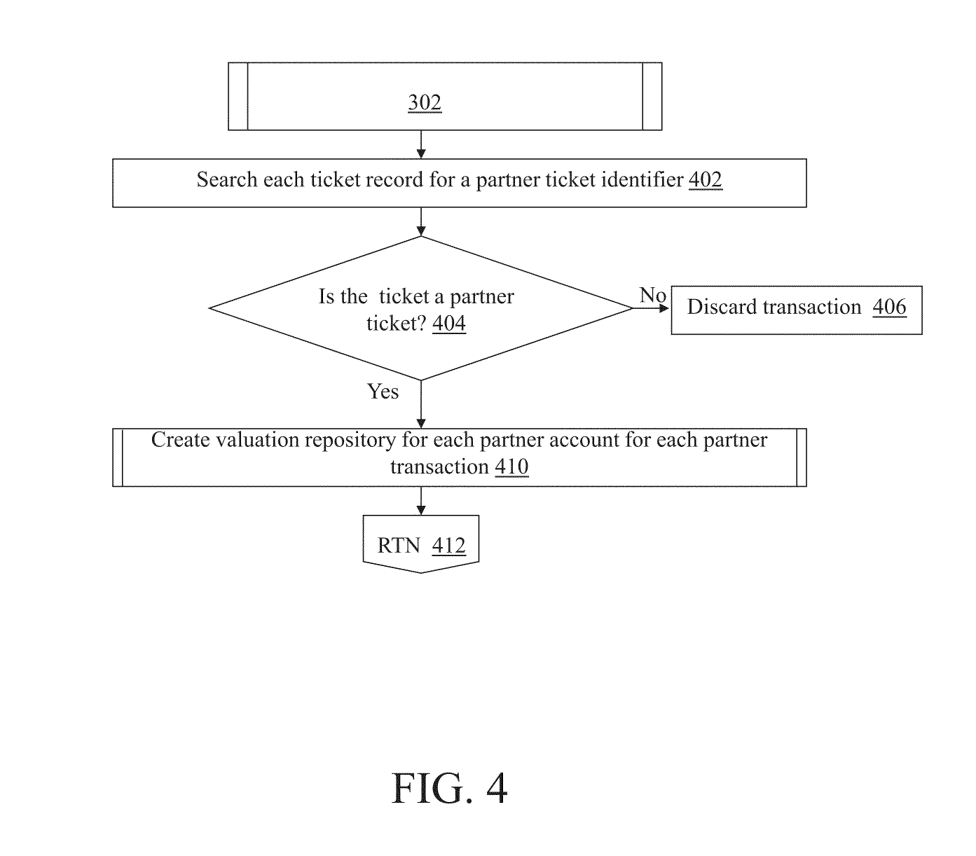

In operation 302, the input engine 202 of the valuation server 102 may forward the list of tickets to the data integrator engine 204 of the valuation server 102. Upon receiving the list of tickets from the input engine 202, in operation 302, the data integrator engine 204 of the valuation server 102 may be configured to identify partner tickets from the list of received tickets. Further, in operation 302, the data integrator engine 204 may be configured to associate the identified partner tickets with a partner account. Operation 302 may be described below in greater detail in association with FIG. 4.

Turning to FIG. 4, this figure is a flow chart that illustrates a process of identifying tickets associated with a partner business, according to certain exemplary embodiments of the present invention. In operation 402, the data integrator engine 204 of the valuation server 102 may search each ticket for a ticket identifier. Further, the data integrator engine 204 may check whether the ticket identifier is associated with a partner business. In an example embodiment, the ticket identifier may include a ticket number, a ticket designator, and/or a PNR number. In operation 404, if the ticket identifier of a ticket is associated with a partner business, then the data integrator engine 204 stores the associated ticket in a ticket repository (not shown in the Figures) as a partner ticket. However, if the ticket identifier of the ticket is not associated with a partner business, then in operation 406, the data integrator engine 204 may discard the ticket. In some embodiments, instead of discarding, the data integrator engine 204 may save the ticket in a separate database for future use.

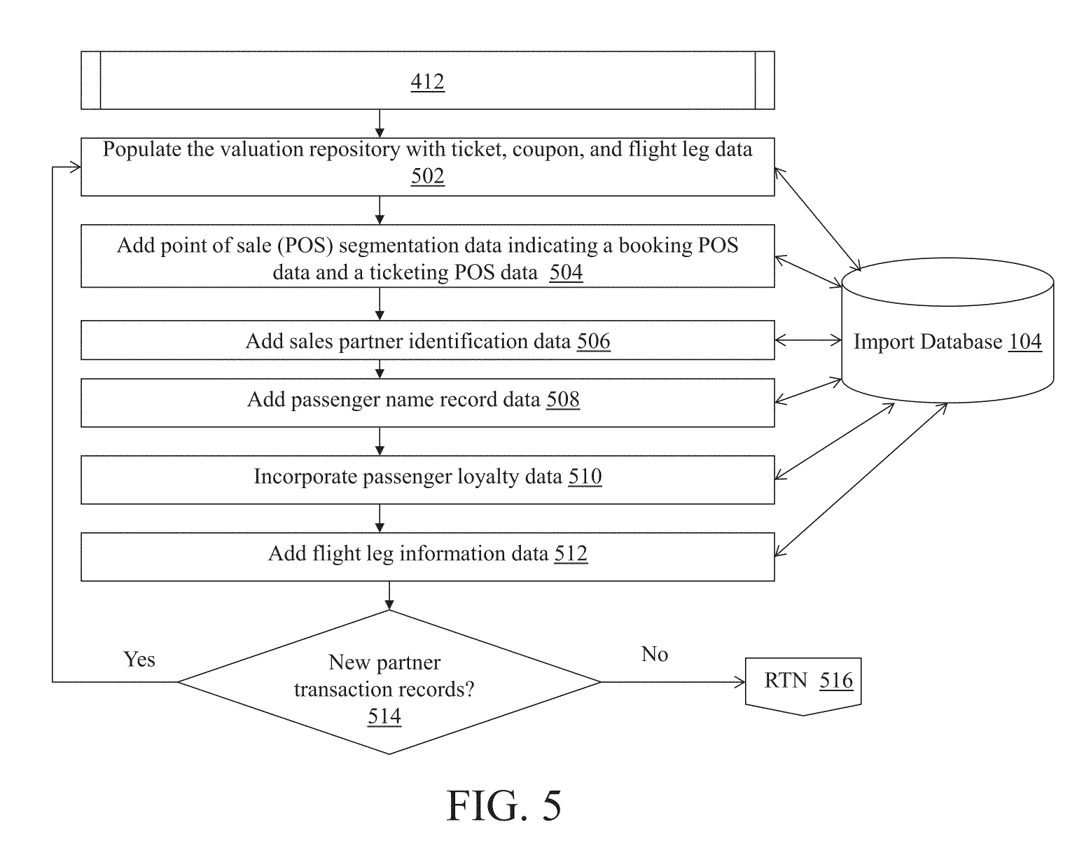

Once the ticket repository is populated with the partner ticket information, in operation 410, the repository generator engine 208 may begin building a valuation repository 226 for each partner business based on the partner tickets. In one embodiment, as described above in association with FIGS. 1 and 2, the valuation repository 226 may be built by populating the valuation repository 226 with a number of identifiers that reference a partner ticket. In another embodiment the identifiers reference a passenger, a partner account, a partner ticket, and any information associated with the partner ticket and/or account. Further, the different identifiers in the valuation repository 226 may be used to identify incentive services associated with the partner ticket. The operation 410 of building the valuation repository 226 may be described in greater detail below in association with FIG. 5.

Now referring to FIG. 5, this figure is a flow chart that illustrates a process of building a valuation repository for each partner account for each partner ticket, according to certain exemplary embodiments of the present invention. In one embodiment, the valuation repository is populated for each partner ticket. In operation 502, the repository generator engine 208 may search the import database 104 to retrieve ticket data, coupon data, and/or flight leg data (data representative of at least one segment of travel from one airport the next), for a given partner ticket. Each of the ticket data, coupon data, and/or the flight leg data may include respective one or more identifiers that can be used to reference the partner ticket. Further, the repository generator engine 502 may load the valuation repository 226 with the respective one or more identifiers that can be used to reference the partner ticket. In other words, in operation 502, the repository generator engine 208 may initially populate the valuation repository 226 with one or more customer identifiers, tickets identifiers, and flight leg identifiers that reference the partner ticket.

In particular, in operation 502, the repository generator engine 208 may search the customer database 104a, the ticket database 104b, and/or the flight leg database 104e to find respective identifiers that can be used to reference the partner ticket. Further, one or more identifiers from each of said databases may be loaded into the valuation repository 226. In an example embodiment, the repository generator engine 208 may populate the valuation repository 226 with identifiers that reference partner tickets that have been used, i.e., the tickets were sold and the flight travel has been completed. In addition, the repository generator engine 208 may populate the valuation repository 226 with identifiers that reference tickets that have been sold, but have not been used due to various reasons, such as cancelled flights, or delayed flights. In some embodiments, the ticket data, coupon data, and/or flight leg data may be retrieved from the ticket and the customer database may be searched to determine if the ticket was used or sold and not used.

After populating the valuation repository 226 with customer identifiers, ticket identifier and/or flight leg identifier, the repository generator engine 208 proceeds to operation 504. In operation 504, the repository generator engine 208 augments the valuation repository 226 by adding point of sales identifiers that reference the partner ticket. In particular, the repository generator engine 208 may search the ticket database 104b and/or sales database 104c to retrieve the point of sales identifiers for a given partner ticket. The point of sales identifiers may identify both the location at which the partner ticket was originally booked and the location at which the partner ticket was ticketed. In some embodiments, both the locations could be same. In other embodiments, the locations may be different.

Further, after populating the valuation repository 226 with the point of sales identifiers, the repository generator engine 208 proceeds to operation 506. In operation 506, the repository generator engine 208 augments the valuation repository 226 by adding identifiers associated with ticket sales that reference the partner ticket. For example, partner business X may have a ticket identifier ABC designated by the airline, for each partner ticket. However, when the partner business X purchases the ticket from another website or third party, the third party may designate a different ticket identifier XYZ to the partner ticket. Continuing with the example, in operation 506, the repository generator 210 may populate the ticket identifier XYZ designated by the third party, since it is associated with the partner ticket. Further, before populating the valuation repository 226 with identifiers associated with ticket sales, the repository generator engine 208 may check if other parameters of the partner ticket matches the corresponding parameters associated with the ticket referenced by the sales identifiers. For example, the repository generator engine 208 may check if the effective dates for the ticket associated with ticket designator XYZ matches the dates on which the partner ticket was flown. If they match, the ticket designator XYZ is populated in the valuation repository 226, and if not, the identifiers associated with sales may not be populated and the tickets from the third party may not be tracked any further.

After populating the valuation repository 226 with identifiers associated with sales (hereinafter ‘sales identifiers’), the repository generator engine 208 may proceed to operation 508. In operation 508, the repository generator engine 208 augments the valuation repository 226 by adding passenger name record (PNR) identifiers that reference the partner ticket. In particular, the repository generator engine 208 may search the booking database 104d, the ticket database 104b, and/or other databases to identify the PNR for a given partner ticket. Further, the valuation repository 226 may be populated with the PNR identifiers that can be used to reference the partner ticket.

After populating the valuation repository 226 with PNR identifiers, the repository generator engine 208 may proceed to operation 510. In operation 510, the repository generator engine 208 augments the valuation repository 226 by adding loyalty identifiers that reference the partner ticket. Further, based on the loyalty identifiers, the repository generator engine 208 may determine any additional customer identifiers that are associated with the loyalty identifiers. In addition, in operation 510 the repository generator engine 208 may retrieve a membership history and customer membership level identifiers as well. Further, the valuation repository 225 may be populated with the additional customer identifier, the customer membership level identifier and/or customer membership history identifier.

After populating the valuation repository 226 with loyalty identifiers, the repository generator engine 208 may proceed to operation 512. In operation 512, the repository generator engine 208 checks if there are any identifiers associated with the flight leg data that needs to be populated in the valuation repository. In other words, the repository generator engine 208 checks for any missing data. If there are any missing data, the repository generator engine 208 may search through multiple databases to retrieve the missing data.

After each operation 502-512, the repository generator engine 208 may check if the ticket is associated with a partner account. If not, the processing of the ticket 208 may be stopped. Alternately, once the valuation repository 226 is populated, the repository generator engine 208 may check if the ticket associated with the partner account.

Once the valuation repository 226 has been populated with identifiers that reference a given ticket, in operation 514, the repository generator engine 208 checks if there are any new partner tickets in the list of tickets. If there are new tickets, then the valuation repository may repeat operations 502-512 to populate identifiers that reference the new ticket, till there are no new tickets present. When the repository generator engine 208 determines that there are no new records, then the repository generator engine 208 returns back to operation 412 in FIG. 4, which in turn returns back to operation 302 of FIG. 3.

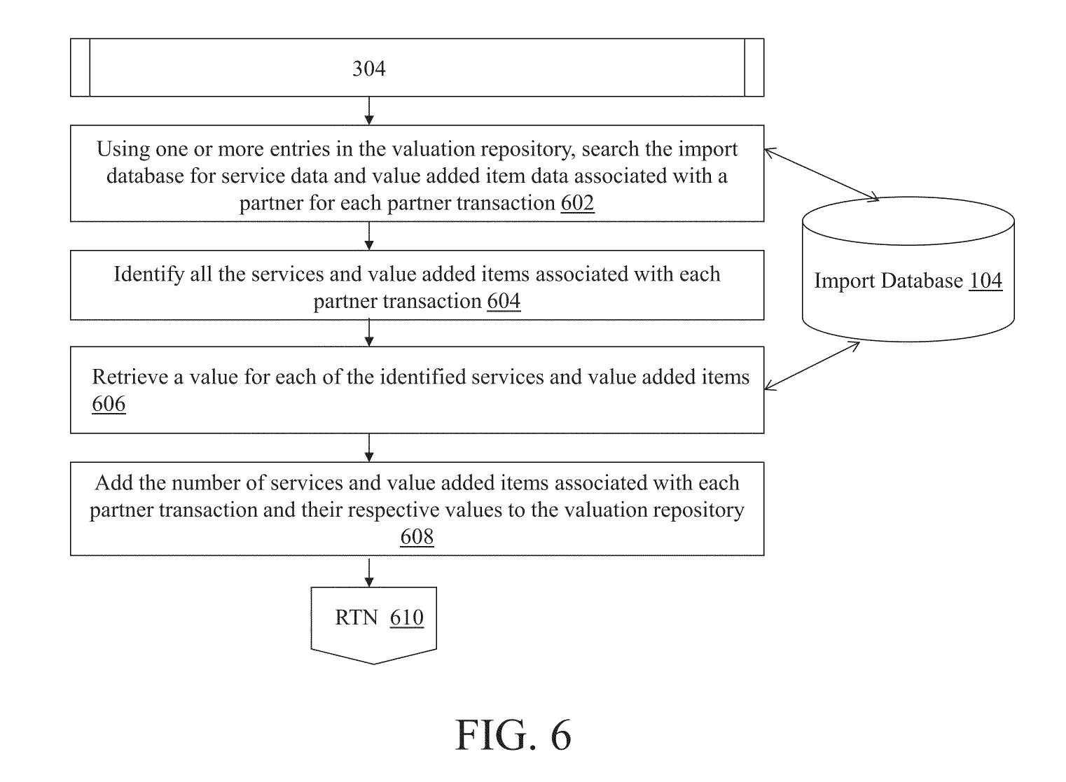

Referring back to FIG. 3, once operation 302 is completed, i.e., once the tickets associated with the partner account is identified and associated with the partner business, then the valuation server 102 proceeds to operation 304. In operation 304, using the identifiers in the valuation repository 226, the partnership valuation engine 210 may consolidate all incentive services (services, products, and value added items provided beyond a contractual agreement) associated with each partner ticket for each partner. Operation 304 may be described in greater detail below in association with FIG. 6.

Now turning to FIG. 6, this figure is a flow chart that illustrates a process of consolidating services and value added products associated with each partner for each partner ticket, according to certain exemplary embodiments of the present invention.

In an example embodiment, incentive services information may be stored as product records in the import database 104. Examples of the product records in the import database that are associated with the incentive services include, but not limited to, a non-monetary incentive record, waivers record including baggage fee waivers and ticket fee waivers, loyalty membership record, customer experience record, customer care records, sales support center records, and/or ticket sales records. Further, each product record may be associated with one or more incentive service. The product record may include information associated with the incentive service represented by the product record, and a value representative of the number of times the incentive services were availed by a partner ticket. In addition, each product record may also include one or more identifiers that reference a partner ticket that availed the incentive services. In other words, each product record may include information representative of the type of incentive service availed, the number of times the incentive service was availed, and one or more identifiers that reference the ticket that availed the respective incentive service.

Now referring to FIG. 6, in operation 602, the partnership valuation engine 210 may search a product record of the import database 104 to check if any identifier in the product record matches any one of the identifiers listed in the valuation repository 226. If the identifiers present in the product record matches at least one identifier listed in the valuation repository 226, then in operation 604, the partnership valuation engine 210 associates the incentive service represented by the product record with the partner ticket referenced by the matching identifier. After associating the product record with the partner ticket, the partnership valuation engine 210 may retrieve a value representative of the number of times an incentive service associated with the product record was availed by the partner ticket. Similarly, the partnership valuation engine 210 may go through each product record of the import database 104 and associate incentive services represented by the product record with the partner ticket based on the identifiers listed in the valuation repository 226. At the end of operation 606, the partnership valuation engine 210 may have a list of product records, associated incentive services, and number of times each of incentive services were availed that are associated with the partner ticket.

For example, the non-monetary incentive record may include a ticket identifier ABCD that references the ticket that was provided with two travel vouchers. After populating the valuation repository 226 for a partner ticket X, the partnership valuation engine 210 may search each product record of the import database 104 to check for any identifier that matches at least one identifier in the valuation repository 226 for the partner ticket X. While searching, the partnership valuation engine 210 may determine that the ticket identifier ABCD of the non-monetary incentive record matches the ticket identifier ABCD of a partner ticket X listed in the valuation repository 226. Upon determining the match, the partnership valuation engine 210 associates the corresponding non-monetary incentive record and/or the travel voucher service to the partner ticket X. Further, the partnership valuation engine 210 retrieves the value corresponding to the number of times the incentive service, i.e., travel vouchers were availed, which is two. Similarly, the partnership valuation engine 210 may go through each product record and eventually obtain a list of incentive services availed by the partner ticket X and the number of times each incentive service was availed in association with the partner ticket.

In some embodiments, in operations 602-608, the partnership valuation engine 210 may search for specific product records rather than searching all the product records in the import database 104. The specific product records may be selected based on the data points that will be presented in the data report. In other word, the search of product records may be limited to those product records that have information relevant to create the data points of the data record.

After the list of incentive services availed by the partner ticket has been identified and the number of times each incentive service was availed has been retrieved, the partnership valuation engine 210 proceeds to operation 608. In operation 608, the partnership valuation engine 210 may list the number of times each incentive service was availed by a partner ticket in a table within the valuation repository 226. In some embodiments, the number of times each incentive service was availed by a partner ticket (herein ‘use value’) may be listed in a table within the partnership valuation report database 224. Further, in operation 608, the partnership valuation engine 210 may retrieve a standardized monetary value for each of the incentive services. In one embodiment, the standardized monetary value for each of the incentive services may be available in the import database 104. In some embodiments, the standardized monetary value may be available from an external database. In either case, the partnership valuation engine 210 may store the standardized monetary value of each of the incentive services in either the valuation repository 226 or the partnership valuation report database 224. In an example embodiment, operations 602-608 may be performed for each partner ticket. When there are no new partner ticket that needs to be consolidated, then, the partnership valuation engine 210 returns to operation 306 in FIG. 3.

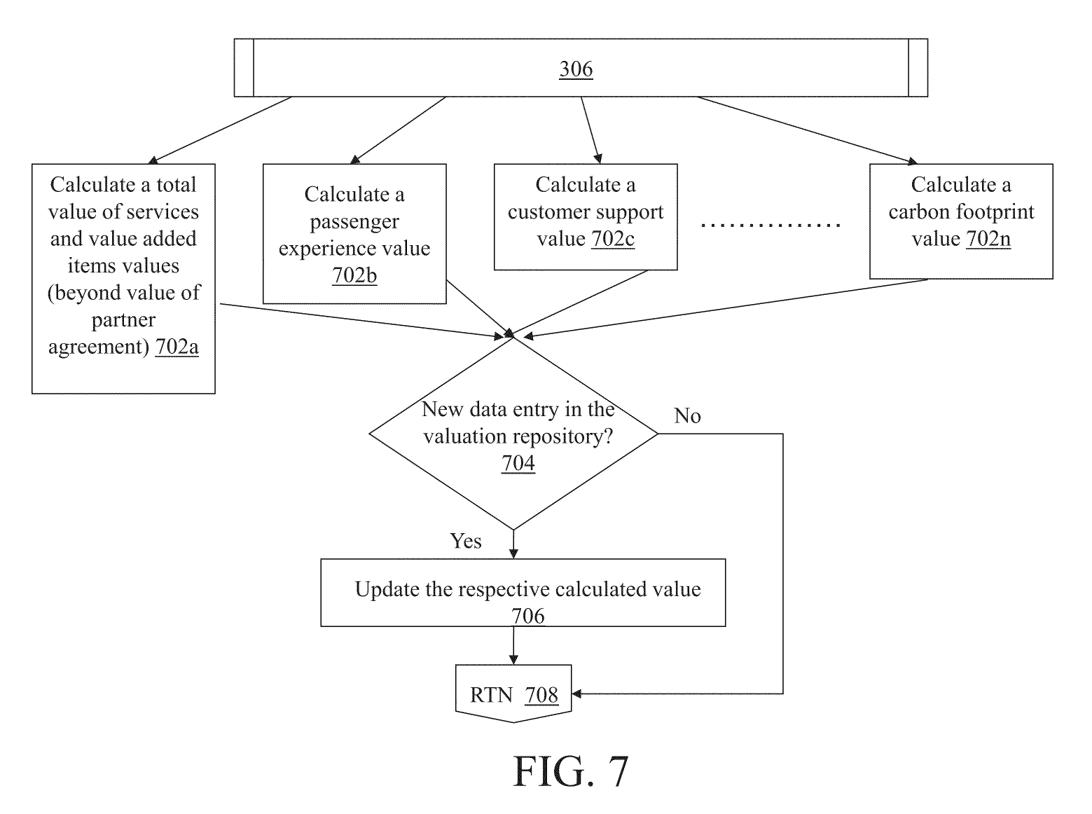

Referring back to FIG. 3, in operation 306, the partnership valuation engine 210 may create a valuation for the incentive services associated with each partner ticket. Operation 306 may be described in greater detail below in association with FIG. 7.

Now referring to FIG. 7, this figure is a flow chart that illustrates a process of calculating values associated with the consolidated services and value added items, according to certain exemplary embodiments of the present invention. In one embodiment, the partnership valuation engine 210 generally calculates the value of each incentive service associated with the partner ticket. In another embodiment, the partnership valuation engine 210 generally calculates a total value of all the incentive services associated with the partner ticket. Further, selected incentive values may be combined to form a derived incentive service value, which will be described below in detail. In yet another embodiment, the partnership valuation engine 210 generally calculates a total value of all the incentive services associated with a partner account. FIG. 7 illustrates examples of the different values of incentive services that are calculated by the partnership valuation engine 210.

In particular, in operation 702b, the value of each incentive service associated with the partner ticket, such as a value of passenger experience. A passenger experience may include many other incentive services such as flight performance in term of flight delays and cancellations, cabin upgrades, baggage fee waivers, etc. In other words, the passenger experience may be a derived incentive service that is formed from the values of the other incentives listed above. The other incentives that form the derived incentive service may be referred to as primary incentive services. So, to calculate the value of passenger experience associated with a partner ticket, the partnership valuation engine 210 may first calculate values of each of the primary incentive services that form the passenger experience value. For example, the partnership valuation engine 210 may calculate a value of the delayed flight associated with the partner ticket, a value of ticket upgrade associated with the partner ticket, and/or a value of the baggage fee waiver. Then, each of these values may be added to calculate the passenger experience value.

As described above in association with FIG. 6, for each incentive service, the partnership valuation engine 210 may retrieve the associated use value and the standardized monetary value from the partnership valuation report database 224. Further, the value of an incentive service may be calculated using the following formula:

Value of Incentive Service=Use Value×Standardized Monetary Value

For example, the use value of a flight delay associated with the partner ticket maybe 1, and the standardized monetary value of the flight delay maybe $400. In the above example, the value of a compensation provided due to flight delay is $400. Similarly, if there are ‘n’ incentive services associated with a partner ticket, the total value of all the incentive services associated with the partner ticket may be calculated as,

$$\begin{matrix}Total value of all incentive services associated with partner ticke t = {\sum }_{k = 1}^{n} Value of incentive {service}_{k} \\ Or & Equation 1 \\ Total value of all incentive services associated with partner ticket = {\sum }_{k = 1}^{n} Use Value of incentive {service}_{k} x Standardized monetary value of incentive {service}_{k} & Equation 2\end{matrix}$$

Further, if there are ‘m’ partner tickets associated with a partner account, each having ‘n’ incentive values, the value of all incentive services provided to a partner business may be calculated as,

$$Equation 3$$

$$Total value of all incentive services associated with a partner account = = {\sum }_{i = 1}^{m} {[ {\sum }_{k = 1}^{n} \begin{matrix}Total value of all incentive services \\ associated with partner {ticket}_{k}\end{matrix} ]}_{i}$$

In another embodiment, if there are ‘1’ incentive services associated with a partner account, the total value of incentive services associated with a partner account may be calculated as,

$$Total value of all incentive services associated with partner t icket = {\sum }_{j = 1}^{l} Use value of incentive {service}_{j} x Standardized monetary value of incentive {service}_{j} \qquad Equation 4$$

In operations 702a-n, the partnership valuation engine 210 calculates values of different incentive services stored in the partnership valuation report database 224, values of different derived incentive services, and/or a total value of incentive services associated with a partner. Further, in operation 704, the partnership valuation engine 210 checks if there are any new entries in each incentive service table stored the partnership valuation report database 224. If there are any new entries in the incentive services table, in operation 706, the value of the respective incentive service may be updated to include the new entry for the incentive service. Further, in operation 706, the derived incentive service values that depend on the updated incentive service value may be updated as well. If there are no new entries to any of the incentive service tables, then the partnership valuation engine 210 may return to operation 308 of FIG. 3.

Returning to FIG. 3, in operation 308, based on the preference of a customer 106, the user interface engine 212 may generate a data report representative of a value of incentive services associated with a partner account. In one embodiment, the user interface engine 212 may determine the data points that are to be included in the data report. Such data points may be determined based on a user preference that is provided by the customer 106 at an earlier time, for example at the time the customer registers to get data reports. The user preference provided by the customer 106 may include a list a data points to be included in the data report, the format of the data report, different font settings in the data report, formats in which the data points are presented, and so on.

Based on the data points included in the data report, the user interface engine 212 may retrieve the calculated values of incentive service and derived interface services from the partnership valuation report database. The user interface engine may further process the calculated values to generate the data report. The processing may include, but not limited to, an average of one or more calculated values, a mean of one or more calculated values, or a percentage value of each of one or more calculated values. In some embodiments, the user interface engine 212 may be configured to pre-fetch or cache one or more calculated values of incentive services based on a determination of the most frequently generated data reports.

Further, once the data reports are generated, the user interface engine 212 may send the data reports to the output engine 214. The output engine 214 may determine the users preferred format. For example, the user may prefer to receive the report as a graph, such as a bar chart, pie chart, etc. In another example, user may prefer the data report in both tabular format and as graphs, wherein the table may be interactive in that the user can click the different data points to sort (ascending or descending order) entries within each column or row. Further, the user can click the data report to get a more detailed reports associated with the selected the data point. Based on the user preference, the output engine 312 may format the data report for presentation and transmit the report to the computing device associated with the customer 106, wherein the data report may be presented on the web interface in operation 814. In some embodiments, the data reports may be sent via email or other digital communication means. Example data reports are described in association with FIGS. 9-10.

Turning now to FIGS. 9 and 10, these figures illustrate example interactive data reports, according to certain exemplary embodiments of the present invention. In particular FIG. 9, illustrates a high level overview of a total partnership value associated with a partner account. In the example data report, the total partnership value may be represented in the form of a pie chart, that comprises a value of incentive services provided beyond a contact value and a value of cost savings obtained through a contractual agreement. One of ordinary skill in the art can understand and appreciate that the data points may be represented in any desired format, for example bar chart, 3-D chart, tabular, and/or percentages. Further, the report provides a high level overview of the total value of incentive services and a break up of different sub categories that form the total value of incentive services, as illustrated by element 902 of FIG. 9. The data report may have provisions that let a user enter comments for example within the account highlights tab. One or ordinary skill in the art can understand and appreciate that even though the example data report illustrated in FIG. 9 comprises at most five tabs, the data report can include any appropriate number of functionally relevant tabs.

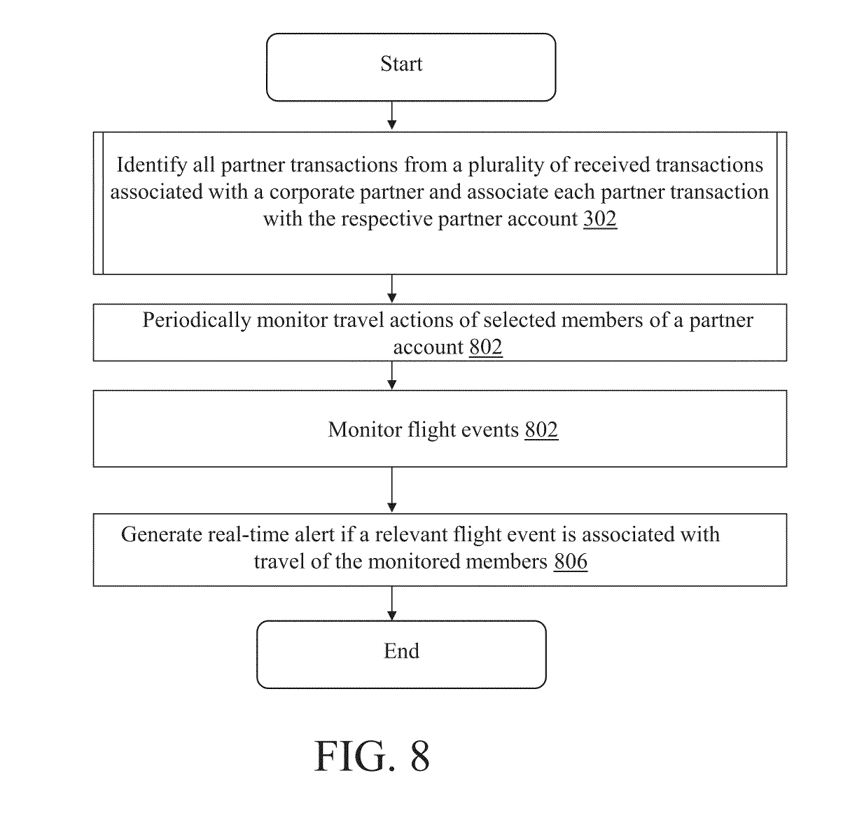

Further, each of the tab may be selectable. Upon clicking and/or selecting a tab, a more detailed report of the selected tab may be generated. For example, upon selecting tab 902, a more detailed report of the selected data point may be generated, which is illustrated in FIG. 10. Similarly each of the other tabs may be selected to view a detailed report of the corresponding selected data points. In addition, the data reports, the valuation server 102 may generate a data alert. The generation of the data alert may be described in greater detail below in association with FIG. 8.

Now referring to FIG. 8, this figure is a flow chart that illustrates a process of real-time alert generation, according to certain exemplary embodiments of the present invention. As described above in FIG. 3, in operation 302, the received list of tickets are identified to be associated with a partner account. Operation 302 is described in greater detail above in association with FIGS. 3-5, and hence may not repeated here. After identifying a partner ticket, a customer identifier associated with the partner ticket may be retrieved. In operation 802, the passenger monitoring engine 216 determines if the partner ticket is selected to be tracked for alert reports based on the customer identifier. If the passenger is to be tracked, then in operation 802, the passenger monitoring engine 216 monitors continuously or discrete intervals any travel action associated with the partner ticket. Examples of travel actions may include, but is not limited to, check ins, i.e., when a passenger travelling on the partner ticket checks in, information may be sent to the passenger monitoring engine 216.

Further, in operation 804, the event tracking engine 218 may be configured to periodically track status of a flight (herein ‘flight event updates’). Examples of the flight event updates may include, but not limited to, flight delays, flight cancellations, airport delays, gate changes, security threats, and/or other important flight event. In some embodiments, the events that are tracked can be updated and/or modified based on a user preference. Upon receiving a flight event update, the event tracking engine 218 may send the update information to the alert generator engine 206. In addition to the flight event updates, the alert generator engine 206 may receive the travel actions associated with the partner ticket.

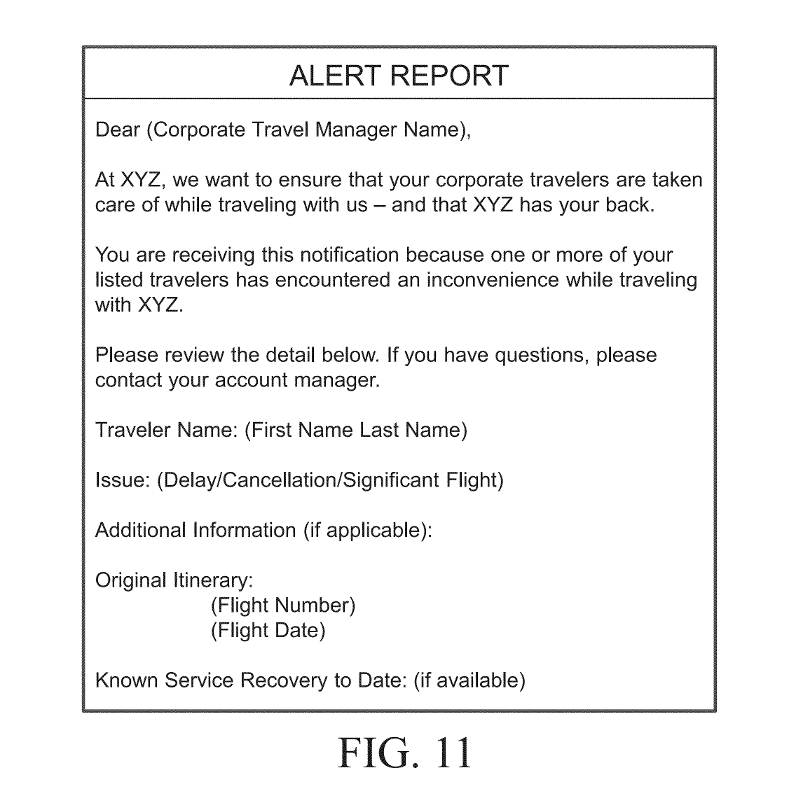

Using the flight event updates and the travel actions, the alert generator engine 206 may generate alert reports if it is determined that the flight event may affect the travel action associated with the partner ticket. For example, if the alert generator engine 206 receives a flight event update that states that flight XYZ is cancelled, the alert generator engine 206 may review the travel actions to check if any travel action such as passenger baggage check-in is associated with flight XYZ. If so, an alert report may be generated and sent to the partner business. An example alert report is illustrated in FIG. 11.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or in Digital Signal Processor (DSP) circuitry).

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow.

It will be appreciated that the various embodiments discussed herein need not necessarily belong to the same group of exemplary embodiments, and may be grouped into various other embodiments not explicitly disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
identifying, by a valuation server, a ticket transaction that is associated with a partner account;
for the identified ticket transaction, generating, by the valuation server, a valuation repository comprising one or more identifiers that are retrieved from a plurality of databases,
wherein each of the one or more identifiers reference the identified ticket transaction;
associating, by the valuation server, a value-added product to the identified ticket transaction based on the one or more identifiers in the valuation repository;
calculating, by the valuation server, a value the value-added product that is associated with the identified ticket transaction; and
generating, by the valuation server, a data report based on the calculated value of the value-added product.

2. The method of claim 1, further comprising generating an alert report for the identified ticket transaction based on occurrence of a predetermined event.

3. The method of claim 2, wherein the predetermined event is a flight delay.

4. The method of claim 2, wherein the predetermined event is a flight cancellation.

5. The method of claim 1, wherein the calculated value of the value-added product is a monetary value.

6. The method of claim 1, wherein calculating the value of the value-added product comprises:
determining, by the valuation server, a number of times each of the value-added products is availed by the identified ticket transaction;
receiving, at the valuation server, a standardized monetary value associated with the value-added product; and
calculating, by the valuation server, the value of the value-added product based on the number of times each of the value-added product is availed and the standardized monetary value associated with the value-added product.

7. The method of claim 1, wherein the data report is associated with the partner account.

8. The method of claim 1, further comprising transmitting the data report for presentation.

9. The method of claim 1, wherein generating a valuation repository comprising one or more identifiers that are retrieved from a plurality of databases comprises:
searching, by the valuation server, each of the one or more databases based on at least one of a ticket number, a partner identifier, and a passenger name record associated with the identified ticket transaction;
receiving, by the valuation server, the one or more identifiers that uniquely references the identified ticket transaction based on a result of the search; and
populating, by the valuation server, the valuation repository with the one or more identifiers.

10. The method of claim 1, wherein associating the value-added products to the identified ticket transaction comprises determining, by the valuation server, if an identifier associated with the value-added product matches at least one identifier in the valuation repository.

11. The method of claim 9, wherein associating one or more value-added products:
retrieving, by the valuation server, information associated with the value-added products that has a matching identifier; and
storing, by the valuation server, the retrieved information associated with the value-added product in a valuation report database.

12. The method of claim 1, wherein the value of the value-added product forms a data point in the data report.

13. A server comprising:
a memory; and
a processor configured to:
identify a ticket transaction that is associated with a partner account;
for the identified ticket transaction, generate a valuation repository comprising one or more identifiers that are retrieved from a plurality of databases,
wherein each of the one or more identifiers reference the identified ticket transaction;
associate a value-added product to the identified ticket transaction based on the one or more identifiers in the valuation repository;
calculate a value the value-added product that is associated with the identified ticket transaction; and
generate a data report based on the calculated value of the value-added product.

14. The server of claim 13, wherein the processor is configured to generate an alert report for the identified ticket transaction based on occurrence of a predetermined event.

15. The server of claim 13, wherein the calculated value of the value-added product is a monetary value.

16. The server of claim 13, wherein calculate a value the value-added product that is associated with the identified ticket transaction comprises:
determine a number of times each of the value-added products is availed by the identified ticket transaction;
receive a standardized monetary value associated with the value-added product; and
calculate the value of the value-added product based on the number of times each of the value-added product is availed and the standardized monetary value associated with the value-added product.

17. A system, comprising:
a computer configured to:
identify a ticket transaction that is associated with a partner account;
for the identified ticket transaction, generate a valuation repository comprising one or more identifiers that are retrieved from a plurality of databases,
wherein each of the one or more identifiers reference the identified ticket transaction;
associate a value-added product to the identified ticket transaction based on the one or more identifiers in the valuation repository; and
calculate a value the value-added product that is associated with the identified ticket transaction.

18. The system of claim 17, wherein the computer is configured to generate a data report based on the calculated value of the value-added product.

19. The system of claim 17, wherein the computer is configured to generate an alert report for the identified ticket transaction based on occurrence of a predetermined event.

20. The system of claim 17, wherein generate a valuation repository comprising one or more identifiers that are retrieved from a plurality of databases comprises:
search each of the one or more databases based on at least one of a ticket number, a partner identifier, and a passenger name record associated with the identified ticket transaction;
receive the one or more identifiers that uniquely references the identified ticket transaction based on a result of the search; and
populate the valuation repository with the one or more identifiers.
